(19) United States
(12) Patent Application Publication
(10) Pub. No.: US 2024/0067044 A1
(43) Pub. Date: Feb. 29, 2024

(54) METHOD FOR GENERATING MATRIX DATA FOR CONVOLUTIONAL NEURAL NETWORK AND LEARNING SYSTEM USING CONVOLUTIONAL NEURAL NETWORK

(71) Applicant: TOYOTA JIDOSHA KABUSHIKI KAISHA, Toyota-shi (JP)

(72) Inventor: Kazuyuki SASAKI, Nisshin-shi (JP)

(73) Assignee: TOYOTA JIDOSHA KABUSHIKI KAISHA, Toyota-shi (JP)

(21) Appl. No.: 18/337,099

(22) Filed: Jun. 19, 2023

(30) Foreign Application Priority Data
Aug. 31, 2022 (JP) 2022-137719

(51) Int. Cl. B60L 58/16; G06N 3/0464

(52) U.S. Cl. CPC B60L 58/16; G06N 3/0464

(57) ABSTRACT

In a method for generating matrix data for a convolutional neural network that performs a convolution operation based on the matrix data in which vehicle information is arranged as an matrix element, the matrix data is composed of predetermined time-series data in which each row changes continuously in terms of time in an arrangement direction of each column, the time-series data is composed of first data of which degree of influence on the convolution operation is high and second data of which degree of influence is lower than the first data, the convolution operation is performed using a kernel that partitions the matrix data into the rows and columns corresponding to a predetermined coefficient, and at least one row of the first data is arranged for each set of rows corresponding to the coefficient.

### CROSS-REFERENCE TO RELATED APPLICATION

This application claims priority to Japanese Patent Application No. 2022-137719 filed on Aug. 31, 2022, incorporated herein by reference in its entirety.

### BACKGROUND

### 1. Technical Field

The present disclosure relates to a convolutional neural network that performs arithmetic (learning) based on collected various types of data and extracts features, and in particular, a method for generating data used in the convolutional neural network, and a learning system using the convolutional neural network.

### 2. Description of Related Art

In recent years, advanced technologies such as artificial intelligence (AI) and information and communication technology (ICT) have been utilized to efficiently implement techniques for performing processes such as learning, inference, recognition, and judgment. Among the above, there is machine learning as a method of learning performed by AI. In the machine learning, a machine (computer) learns by itself using a large amount of given data, optimizes output data with respect to input data based on the learning results (learned model), and performs estimation and prediction based on the output data. One example of such machine learning is processing technology using a convolutional neural network (CNN). The convolutional neural network is used in various fields such as image recognition, speech recognition, natural language processing, and machine translation.

Japanese Unexamined Patent Application Publication No. 2019-168453 (JP 2019-168453 A) discloses a technique for estimating deterioration of a power storage element using the convolutional neural network as described above. A deterioration estimating device described in JP 2019-168453 A acquires a state of health (SOH) of the power storage element at a first time point and the SOH at a second time point after the first time point. Along with this, the learning model is learned based on time-series data relating to the state of the power storage element from the first time point to the second time point, and learning data in which the SOH at the first time point is input data and the SOH at the second time point is output data. Then, the deterioration state of the power storage element is estimated based on the learned learning model.

Japanese Unexamined Patent Application Publication No. 2020-148560 (JP 2020-148560 A) describes a battery life learning device intended to accurately predict the remaining life of a vehicle battery. The battery life learning device described in JP 2020-148560 A predicts the remaining life of the vehicle battery using a neural network. Specifically, the battery life learning device described in JP 2020-148560 A causes learning of a prediction model for predicting the remaining life of the vehicle battery from the time-series data of a deterioration index of the vehicle battery based on the learning data including the time-series data of the deterioration index at a predetermined point in the past of a “vehicle battery for learning” that has reached the end of its life and the remaining life, and acquires the learned prediction model. Then, the remaining life of the “prediction target vehicle battery” is predicted based on the time-series data of the deterioration index of the “prediction target vehicle battery” and the learned prediction model.

### SUMMARY

The deterioration estimation device described in JP 2019-168453 A and the battery life learning device described in JP 2020-148560 A generate a learned model (prediction model) using a neural network, and estimates the deterioration state and the remaining life of the power storage element or the vehicle battery. For example, in the deterioration estimation device described in JP 2019-168453 A, the time-series data related to the SOC of the power storage element based on the voltage data of the power storage element is input to the convolutional neural network, and the deterioration state of the power storage element is estimated. Further, in the battery life learning device described in JP 2020-148560 A, battery information such as internal resistance, voltage, current, temperature, charge amount, and full charge capacity of the vehicle battery is input to the neural network, and the remaining life of the vehicle battery is predicted. In addition, for example, there is a related art in which a value obtained by correcting the starting voltage of the vehicle battery with the outside air temperature is input to a neural network to estimate the deterioration state of the vehicle battery. It is possible to accurately estimate the deterioration state and remaining life of the battery by taking in data that directly affects the performance and deterioration state of the battery or by taking in data that has a high degree of influence, and using a neural network. However, for example, as the vehicle battery described in JP 2020-148560 A, in addition to direct battery information such as the internal resistance and voltage of the vehicle battery, there is data that is related to the traveling state and the usage state of the vehicle and indirectly affects the performance and deterioration state of the vehicle battery. However, in the related art as described above, peripheral data including factors related to performance and the deterioration state of the battery other than data with a high degree of influence is not utilized. Further, no technology has been established for taking in such peripheral data and utilizing the data appropriately.

As described above, there is still room for improvement for more accurate prediction or estimation of the changing state of a predetermined device, member, substance, etc. that changes (deteriorates) continuously in terms of time by applying a neural network, particularly a convolutional neural network that exhibits advanced recognition performance or learning performance.

The present disclosure has been devised by focusing on the above technical issues, and an object thereof is to provide a method for generating matrix data for a convolutional neural network capable of accurately predicting or estimating the changing state of a device, a member, a substance, etc. that changes continuously in terms of time and a learning system and a learning device using the convolutional neural network.

In order to achieve the above object, the present disclosure is a method for generating matrix data for a convolutional neural network that performs a convolution operation based on the matrix data in which predetermined information is arranged as a matrix element, and the matrix data is composed of time-series data of a predetermined item in which each row of the matrix data changes continuously in terms of time in an arrangement direction of each column of the matrix data, the time-series data is composed of first data of which a degree of influence on the convolution operation is high and second data of which the degree of influence is lower than the first data, the convolution operation is performed using a kernel (or a filter or a mask) that partitions the matrix data into the rows and the columns corresponding to a predetermined coefficient, and at least one row of the first data is arranged for each set of the rows of the matrix data corresponding to the coefficient, and the second data is arranged in the remaining rows except for the row of the matrix data in which the first data is arranged.

Further, the present disclosure is a method for generating matrix data for a convolutional neural network that performs a convolution operation based on the matrix data in which vehicle information with a behavior and a state of each component of a vehicle detected is arranged as a component of a matrix and estimates a state of a temporal change of a predetermined element of the vehicle, and the matrix data may be composed of time-series data of the vehicle information in which each row of the matrix data changes continuously in terms of time in an arrangement direction of each column of the matrix data, the time-series data may be composed of first data of which a degree of influence on the convolution operation is high and that includes at least data related to a primary factor of the temporal change and second data of which the degree of influence is lower than the first data, the convolution operation may be performed using a kernel (or a filter or a mask) that partitions the matrix data into the rows and the columns corresponding to a predetermined coefficient, at least one row of the first data may be arranged for each set of the rows of the matrix data corresponding to the coefficient, and the second data may be arranged in the remaining rows except for the row of the matrix data in which the first data is arranged.

Further, the convolutional neural network according to the present disclosure may be for estimating a deterioration state of a power storage device mounted on the vehicle, and the first data according to the present disclosure may include at least data related to a voltage of the power storage device.

Further, the present disclosure is a learning system provided with a control unit mounted on a vehicle and a server installed outside the vehicle, the learning system using a convolutional neural network that estimates a state of a temporal change of a predetermined element of the vehicle by performing a convolution operation based on matrix data in which predetermined information is arranged as a component of a matrix. The control unit may acquire vehicle information with a behavior and a state of each component of the vehicle detected, and transmit the vehicle information to the server. The server may configure the matrix data using time-series data of the vehicle information in which each row of the matrix data changes continuously in terms of time in an arrangement direction of each column of the matrix data, configure the time-series data using first data of which a degree of influence on the convolution operation is high and that includes at least data related to a primary factor of the temporal change and second data of which the degree of influence is lower than the first data, perform the convolution operation using a kernel (or a filter or a mask) that partitions the matrix data into the rows and the columns corresponding to a predetermined coefficient, arrange at least one row of the first data for each set of the rows of the matrix data corresponding to the coefficient, arrange the second data in the remaining rows except for the row of the matrix data in which the first data is arranged, and estimate the state of the temporal change by performing the convolution operation.

Further, the convolutional neural network used in the learning system according to the present disclosure may be for estimating a deterioration state of a power storage device mounted on the vehicle, and the first data according to the present disclosure may include at least data related to a voltage of the power storage device.

Further, the present disclosure is a learning device using a convolutional neural network that estimates a state of a temporal change of a predetermined element of a vehicle by performing a convolution operation based on matrix data in which vehicle information with a behavior and a state of each component of the vehicle detected is arranged as a component of a matrix, and may include: a detection unit that detects the behavior and the state of the each component; a data acquisition unit that acquires data detected by the detection unit as the vehicle information; a data generation unit that configures the matrix data using time-series data of the vehicle information in which each row of the matrix data changes continuously in terms of time in an arrangement direction of each column of the matrix data, configures the time-series data using first data of which a degree of influence on the convolution operation is high and that includes at least data related to a primary factor of the temporal change and second data of which the degree of influence is lower than the first data, arrange at least one row of the first data for each set of the rows corresponding to a predetermined coefficient of a kernel (or a filter or a mask) that partitions the matrix data into the rows and the columns corresponding to the coefficient, and arranges the second data in the remaining rows except for the row in which the first data is arranged; an arithmetic unit that performs the convolution operation using the kernel (or the filter or the mask), and a learning unit that estimates a state of the temporal change of the vehicle based on a result obtained by performing the convolution operation.

Then, the convolutional neural network used in the learning device according to the present disclosure may be for estimating a deterioration state of a power storage device mounted on the vehicle, and the first data according to the present disclosure may include at least data related to a voltage of the power storage device.

The “kernel” in the present disclosure may also be referred to as a “filter”, a “mask”, or a “window” as described above. Therefore, the “kernel” in the present disclosure can be read as any of the “filter”, the “mask” or the “window”. In the description of the present disclosure and the embodiment of the present disclosure below, the term “kernel” will be primarily used.

The present disclosure performs learning using a convolutional neural network, and estimates or predicts the state of a temporal change of the predetermined element of the vehicle by applying a learning result. For example, the state of deterioration of a power storage device mounted on a vehicle, that is, the state of a temporal change in battery performance is estimated. In the convolutional neural network applied in the present disclosure, for example, the convolution operation is performed using the matrix data in which the predetermined information such as the vehicle information related to the behavior and the state of each component of the vehicle is arranged as a matrix element. For example, learning for estimating the state of the temporal change or the state of deterioration of the vehicle can be performed with high accuracy by performing learning using the data subjected to the convolution operation.

The matrix data that is input data for the convolution operation is generated, for example, by storing each data of the predetermined information (for example, the vehicle information) in a component or a cell obtained by dividing the entire input data into a grid. In the matrix data in the convolutional neural network according to the present disclosure, the time-series data of a predetermined item that changes continuously in terms of time is arranged in the arrangement direction of each column of the matrix data (or the order direction of the arrangement or the column number direction) and stored. The time-series data according to the present disclosure is composed of the first data that is the primary factor of the convolution operation and the second data that is the secondary factor of the convolution operation. That is, the time-series data is composed of the first data of which degree of influence on the convolution operation is high and the second data of which degree of influence on the convolution operation is lower than that of the first data. Therefore, in the matrix data according to the present disclosure, the first data and the second data are alternately arranged in the row direction (vertical direction) of the matrix data. Along with this, the first data and the second data are arranged such that at least one row of the kernel (or the filter or the mask) in the convolution operation is the first data. That is, the first data and the second data in the matrix data are arranged such that the kernel (or the filter or the mask) in the convolution operation always includes at least one row of the first data. Specifically, when the coefficient that determines the size of the kernel (or the filter or the mask) is “n”, the kernel (or the filter or the mask) has a size of n rows by n columns, and the matrix data is generated such that at least one row among the n rows is the first data. For example, when the kernel (or the filter or the mask) with a coefficient of “3” is used, the matrix data is generated such that at least one row of the first data is arranged every three rows. The second data is arranged in the remaining rows except for the row in which the first data is arranged.

In the convolutional neural network using the matrix data generated as described above, the main features of a learning target to be learned by the convolution operation are accurately extracted using the first data. At the same time, the secondary features of the learning target are extracted using the second data. Then, the first data and the second data are combined (convolved) in a composite manner, and learning is performed based on the convolution operation. For example, the state of deterioration of the power storage element mounted on the vehicle is used as a learning object, and the starting voltage of the power storage element is taken into the convolutional neural network as the first data. Further, factors other than the first data related to the deterioration state of the power storage element, such as the state of use and the environment of use of the vehicle, are taken into the convolutional neural network as the second data. Therefore, as compared with the conventional learning using only the primary factor such as the first data in the present disclosure, or the conventional learning in which the primary factor is simply corrected, the learning with higher accuracy can be performed in the convolutional neural network according to the present disclosure.

Therefore, according to the present disclosure, the state of changes of a device, a member, a material or the like that continuously changes in terms of time, for example, the deterioration state of the power storage element mounted on the vehicle, can be appropriately and accurately estimated by applying the convolutional neural network.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a configuration and a control system of a vehicle that is a learning target to be learned by a convolutional neural network according to the present disclosure;

FIG. 2 is a block diagram for describing an in-vehicle control unit and an external server in a learning system and a learning device using the convolutional neural network of the present disclosure;

FIG. 3A is a diagram showing matrix data and a kernel (or a filter or a mask) used in the convolution operation of the convolutional neural network of the present disclosure, and FIG. 3A shows an image of data stored in the matrix data. FIG. 3B is a diagram showing the matrix data and the kernel (or the filter or the mask) used in the convolution operation of the convolutional neural network of the present disclosure, and FIG. 3B shows an image of the kernel (or the filter or the mask);

FIG. 4 is a diagram showing the matrix data and the kernel (or the filter or the mask) used in the convolution operation of the convolutional neural network of the present disclosure, particularly time-series data constituting the matrix data of the present disclosure, and images of first data and second data that constitute the time-series data;

FIG. 5 is a diagram for describing an example of control executed by a learning system and a learning device using a convolutional neural network according to the present disclosure, and is a flowchart showing the control contents including the method for generating the matrix data for the convolutional neural network; and

FIG. 6 is a diagram for describing an example of the convolution operation to be executed using the matrix data shown in FIGS. 3A, 3B, and shows an image of movement (stride) of the kernel (or the filter or the mask).

### DETAILED DESCRIPTION OF EMBODIMENTS

An embodiment of the present disclosure will be described with reference to the drawings. It should be noted that the embodiment shown below is merely an example when the present disclosure is embodied, and does not limit the present disclosure.

A learning system and a learning device using a convolutional neural network according to the embodiment of the present disclosure perform a convolution operation based on a large amount of collected information, and extract features of an information source. For example, with an existing general vehicle as the control target, the state of temporal change of a predetermined element of the vehicle is estimated. In that case, the learning system and the learning device using a convolutional neural network in the embodiment of the present disclosure include a control unit mounted on the vehicle and a server installed outside the vehicle.

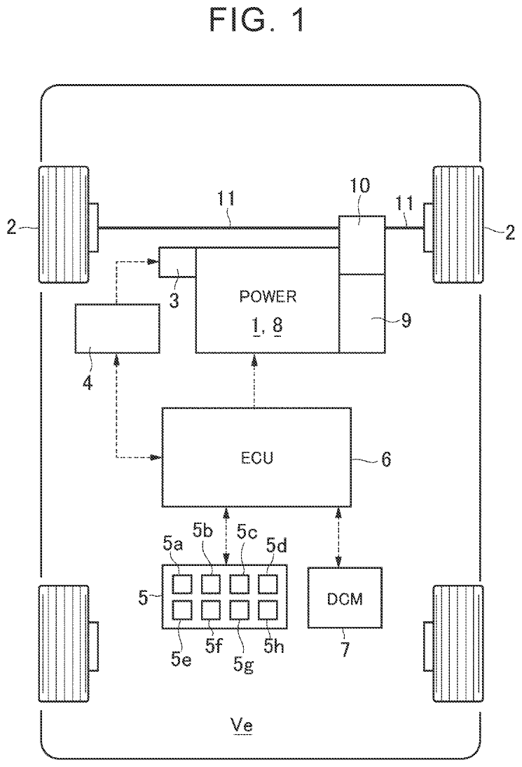

FIG. 1 shows an example of a vehicle equipped with a control unit as a component of a learning system and a learning device using a convolutional neural network according to the embodiment of the present disclosure. A vehicle Ve shown in FIG. 1 includes, as main components, a drive power source (POWER) 1, drive wheels 2, a starter motor 3, a battery 4, a detection unit 5, a control unit (electronic control unit; ECU) 6, and a communication module (DCM) 7.

The drive power source 1 is a power source that outputs drive torque for causing the vehicle Ve to travel. The drive power source 1 is, for example, an internal combustion engine such as a gasoline engine or a diesel engine, and is configured such that adjustment of an output and operating states such as starting and stopping are electrically controlled. In the case of a gasoline engine, an opening degree of a throttle valve, an amount of fuel supplied or injected, execution and stop of ignition, ignition timing, etc. are electrically controlled. Alternatively, in the case of a diesel engine, a fuel injection amount, a fuel injection timing, or an opening degree of a throttle valve (in an exhaust gas recirculation (EGR) system) is electrically controlled. In the example shown in FIG. 1, as the drive power source 1, an engine 8 provided with a starter motor 3 that will be described later is mounted.

The drive power source 1 may be, for example, a permanent magnet type synchronous motor or an electric motor such as an induction motor. The electric motor in this case may be, for example, a so-called motor-generator that has both functions as a prime mover that outputs torque by being driven by supply of electric power, and as a generator that generates electricity by being driven by receiving torque from the outside. In the case of the motor generator, the number of revolutions, torque, or switching between functions as a prime mover and as a generator are electrically controlled. Also, the drive power source 1 may be a so-called hybrid drive unit in which both an engine 8 and an electric motor (motor generator) are mounted.

The drive wheels 2 generate the drive force of the vehicle Ve as the drive torque output by the drive power source 1 is transmitted. In the embodiment shown in FIG. 1, the drive wheels 2 are connected to the drive power source 1 via a transmission 9, a differential gear 10, and a drive shaft 11. Note that the vehicle Ve in the embodiment of the present disclosure may be a front-wheel drive vehicle in which the drive torque is transmitted to the front wheels and the drive force is generated by the front wheels, as in the embodiment shown in FIG. 1. Alternatively, the vehicle Ve may be a rear-wheel drive vehicle that transmits the drive torque to the rear wheels via, for example, a propeller shaft (not shown) or the like and generates the drive force by the rear wheels. Alternatively, the vehicle Ve may be a four-wheel drive vehicle in which a transfer mechanism (not shown) is provided to transmit the drive torque to both the front and rear wheels and generate the drive force in both the front and rear wheels.

When the engine 8 is mounted as the drive power source 1 of the vehicle Ve as described above, the starter motor 3 is mounted on the engine 8 and drives a crankshaft (not shown) when the engine 8 is started. The starter motor 3 operates as electric power is supplied from the battery 4 that will be described later. Instead of the starter motor 3, an alternator (not shown) may function as a starter for the engine 8. Alternatively, a motor (not shown) having both a starter function and an alternator function may be used.

The battery 4 corresponds to a “power storage device” in the embodiment of the present disclosure, and supplies electric power to the starter motor 3 described above. In the example shown in FIG. 1, the battery 4 is a so-called auxiliary battery, and supplies electric power to in-vehicle equipment (not shown) such as a lighting lamp and an air conditioner of the vehicle Ve. Note that the “power storage device” in the embodiment of the present disclosure can be, for example, a main battery or a drive battery (not shown) in a hybrid electric vehicle or a battery electric vehicle.

The detection unit 5 is an instrument or a device for acquiring various types of data and information necessary for controlling the vehicle Ve, and includes, for example, a power supply unit, a microcomputer, sensors, an input-output interface, and the like. In particular, the detection unit 5 according to the embodiment of the present disclosure includes a battery voltage sensor 5a that detects voltage of the battery 4 as information having a high degree of influence or relevance to deterioration of the “power storage device”, that is, the battery 4, when the state of deterioration of the battery 4 is estimated. Further, the detection unit 5 includes a traveling distance sensor 5b that detects a traveling distance of the vehicle Ve, an outside air temperature sensor 5c that detects the outside air temperature, a battery temperature sensor 5d that detects the temperature of the battery 4, a timer 5e that measures the traveling time, parking time, etc. of the vehicle Ve, and a counter 5f that measures the number of times the engine 8 is started as information that has a lower degree of influence or relevance to the deterioration of the battery 4 than the voltage of the battery 4, but that affects deterioration of the battery 4 indirectly or compoundly. In addition, the detection unit 5 includes, for example, a vehicle speed sensor (or a wheel speed sensor) 5g that detects the vehicle speed, an engine speed sensor 5h that detects the engine speed of the engine 8, and the like. Further, the detection unit 5 includes, for example, a global positioning system (GPS) receiver (not shown) for acquiring position information of the vehicle Ve, an in-vehicle camera (not shown) that acquires imaging information related to the external situation of the vehicle Ve, and the like. The detection unit 5 is electrically connected to the control unit 6 that will be described later, and outputs to the control unit 6 electric signals corresponding to detection values or calculated values of various sensors, instruments, devices, etc., described above or position information, etc., as detection data.

The control unit 6 is, for example, an electronic control device mainly composed of a microcomputer, and comprehensively controls the vehicle Ve. Various types of data detected or measured by the detection unit 5 above are input to the control unit 6. Therefore, the control unit 6 includes a data acquisition unit 6a that will be described later. Then, the control unit 6 transmits various types of data input to the data acquisition unit 6a to the external server 101 that will be described later via a communication module 7 that will be described later. At the same time, the control unit 6 performs arithmetic using various types of input data, pre-stored data, calculation formulas, and the like. The control unit 6 is configured to output the arithmetic result as a control command signal to control an operation of each component of the vehicle Ve, for example. Although FIG. 1 shows an example in which one vehicle Ve is provided with one control unit 6, a plurality of the control units 6 may be provided for each device or instrument to be controlled or for each control content.

The communication module 7 transmits and receives data between the control unit 6 of the vehicle Ve and a server 101 provided outside the vehicle Ve that will be described later. The communication module 7, for example, includes a dedicated wireless communication system (not shown) called data communication module (DCM) installed in the vehicle Ve, and uses a dedicated communication line between the control unit 6 and the server 101 to transmit and receive various types of data. In the embodiment of the present disclosure, general-purpose communication equipment (not shown) may be used to transmit and receive data using a general mobile communication line. Alternatively, for example, data may be transmitted and received using wired communication equipment installed in a dealer of the vehicle Ve, a maintenance shop, or the like.

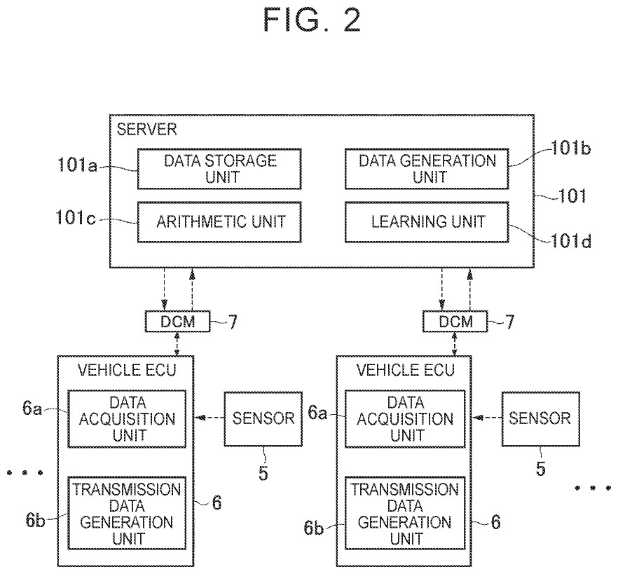

In the learning system and the learning device using a convolutional neural network according to the embodiment of the present disclosure, the control unit 6 transmits and receives data to and from the server 101 provided outside the vehicle Ve, as will be described later, and performs machine learning in cooperation with the server 101. Specifically, the state of a temporal change of a predetermined element of the vehicle Ve (for example, the deterioration state of the battery 4 as described above) is estimated using the convolutional neural network. Therefore, as shown in FIG. 2, the learning system and the learning device using the convolutional neural network in the embodiment of the present disclosure includes the in-vehicle control unit 6 described above and the server 101 installed outside the vehicle Ve.

Specifically, the control unit (ECU) 6 of the vehicle Ve includes the above-described data acquisition unit 6a and a transmission data generation unit 6b.

The data acquisition unit 6a acquires predetermined data necessary for generating learning data (matrix data described later) of the convolutional neural network for each vehicle Ve. The various types of data detected by the detection unit 5 described above are acquired as vehicle information for generating the learning data for the convolutional neural network, when necessary.

The transmission data generation unit 6b processes the various types of data acquired by the data acquisition unit 6a into transmission data adapted to the communication module 7 as the learning data used in the convolutional neural network, and transmits the data to the server 101 via the communication module 7.

Note that FIG. 2 shows a situation in which two of the control units 6 each transmit and receive data to and from the server 101. That is, FIG. 2 shows the control unit 6 mounted on each of the two vehicles Ve and one server 101 set outside. The learning system and the learning device using the convolutional neural network according to the embodiment of the present disclosure perform a machine learning (convolution operation) using various types of data collected from the vehicle Ve. It is desirable to collect as much data as possible over the widest possible range so as to improve the learning accuracy of the convolutional neural network. Therefore, the learning system and the learning device using the convolutional neural network according to the embodiment of the present disclosure are not limited to two vehicles Ve as shown in FIG. 2, and a large amount of data are collected from the control units 6 respectively mounted on a large number of vehicles Ve.

On the other hand, the server 101 installed outside the vehicle Ve includes, for example, a data storage unit 101a, a data generation unit 101b, an arithmetic unit 101c, and a learning unit 101d.

The data storage unit 101a stores various types of data and information received from the control unit 6 of each vehicle Ve and various types of data and information subjected to arithmetic processing by the server 101 in a storage medium (not shown) as a database related to the vehicle information.

The data generation unit 101b generates input data used in the convolutional neural network according to the embodiment of the present disclosure from a large amount of data stored in the data storage unit 101a, that is, the vehicle information. The convolutional neural network according to the embodiment of the present disclosure performs a convolution operation based on the matrix data in which predetermined information is arranged as a matrix element. The data generation unit 101b configures the matrix data from time-series data of the vehicle information in which each row of the matrix data changes continuously in terms of time in an arrangement direction of each column of the matrix data.

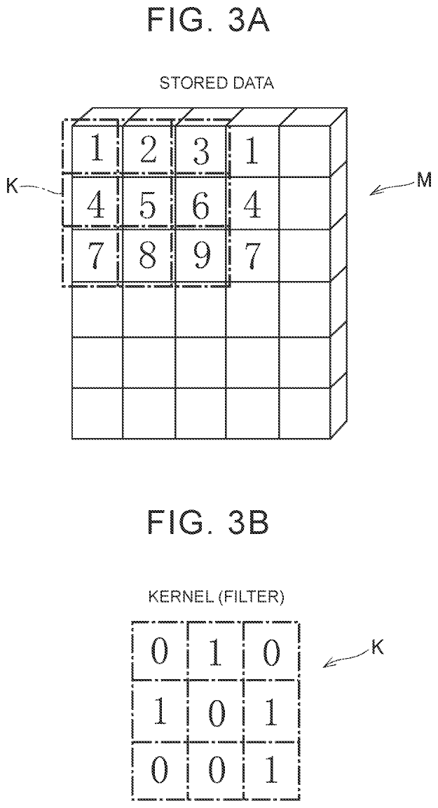

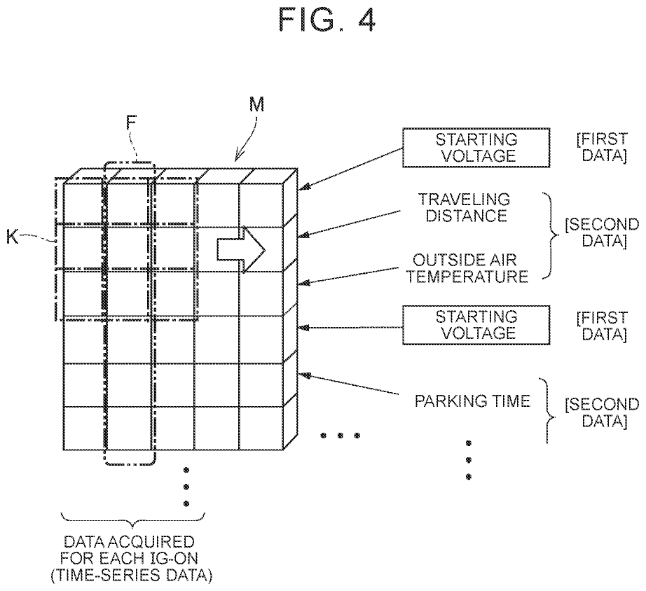

Specifically, as shown in FIGS. 3A and 4, the data generation unit 101b generates matrix data M that is the input data of the convolution operation by storing each data of the vehicle information to a component or a cell obtained by dividing the entire input data into a grid, for example. In this case, the data generation unit 101b arranges the time-series data of a predetermined item that changes continuously in terms of time in the arrangement direction of each column of the matrix data (or the order direction of the arrangement or the column number direction) and stores the data.

Further, as shown in FIG. 4, the data generation unit 101b configures two types of data having different items, that is, first data that is the primary factor of the convolution operation and second data that is the secondary factor of the convolution operation, by dividing the time-series data of the vehicle information that constitutes the matrix data M. The first data has a high degree of influence on the convolution operation of the convolutional neural network and includes at least data related to the primary factor of the temporal change of the predetermined element of the vehicle Ve. For example, when the deterioration state of the battery 4 is estimated as described above, the time-series data related to a voltage (for example, a starting voltage) of the battery 4 that has a high degree of influence on the deterioration of the battery 4, that is, has a high relevancy to the primary factor of the temporal change (deterioration) of the performance of the battery 4, is arranged in the matrix data M as the first data. On the other hand, the second data is data that has a lower degree of influence on the convolution operation than the first data, and is data that indirectly or compoundly influences deterioration of the battery 4. For example, except for the voltage of the battery 4, time-series data related to the traveling distance of the vehicle Ve, the traveling time of the vehicle Ve, the outside air temperature, the temperature of the battery 4, and the like are arranged in the matrix data M as the second data. Therefore, the first data and the second data are alternately arranged in the row direction (vertical direction) of the matrix data M.

Furthermore, as shown in FIG. 4, the data generation unit 101b arranges at least one row of the first data for corresponding number of rows to a coefficient of a kernel (or a filter or a mask) K in the convolution operation of the convolutional neural network. The kernel K is a convolution layer that is also called a “filter”, a “mask”, or a “window” in the convolution operation, and is a set (matrix) of data arranged into a grid in which the matrix data described above is partitioned into rows and columns in the number of a predetermined coefficient. The coefficient of the kernel K is a numerical value that determines the size of the kernel K or the amount of data. For example, when the coefficient of the kernel K is “n”, the kernel K becomes a matrix of n rows by n columns. Then, the data generation unit 101b arranges the first data and the second data in the matrix data M such that at least one row of the kernel K is the first data. That is, the first data and the second data in the matrix data M are alternately arranged such that the kernel K in the convolution operation always includes at least one row of the first data. As shown in FIG. 3B and FIG. 4, when the kernel K with a coefficient of “3” is used, the matrix data M is generated such that at least one row of the first data is arranged every three rows. At the same time, the matrix data M is generated by arranging the second data in the remaining rows other than the row in which the first data is arranged.

The arithmetic unit 101c performs the convolution operation in the convolutional neural network based on the matrix data M (time-series data of the vehicle information) generated by the data generation unit 101b as described above. The convolutional neural network according to the embodiment of the present disclosure is characteristic in the point that the convolution operation is performed using the time-series data divided into the first data and the second data as described above and the matrix data M generated such that the time-series data is arranged so as to include at least one row of the first data for each kernel K size (number of rows). The operation method of the convolution operation is executed in the same manner as in a conventional convolutional neural network. For example, it is possible to perform the convolution operation using the operation method similar to that of the convolutional neural network described in JP 2019-168453 A described above.

The learning unit 101d estimates the state of the temporal change of the vehicle Ve based on the result of the convolution operation performed by the arithmetic unit 101c. For example, the deterioration state of the battery 4 as described above, that is, the state of the temporal change of performance of the battery 4 is estimated. When an abnormality that requires treatment such as repair or replacement is detected as a result of estimation of the state of the temporal change as described above, for example, an abnormality detection flag is turned ON, and a predetermined action (for example, warning display, notification, contact, etc.) is executed.

As described above, the learning system and the learning device using the convolutional neural network according to the embodiment of the present disclosure has a main object to, in particular, predict or estimate the state of the temporal change of the vehicle Ve by applying the convolutional neural network. Therefore, the learning system and the learning device using the convolutional neural network according to the embodiment of the present disclosure are configured to execute control shown in the following flowchart.

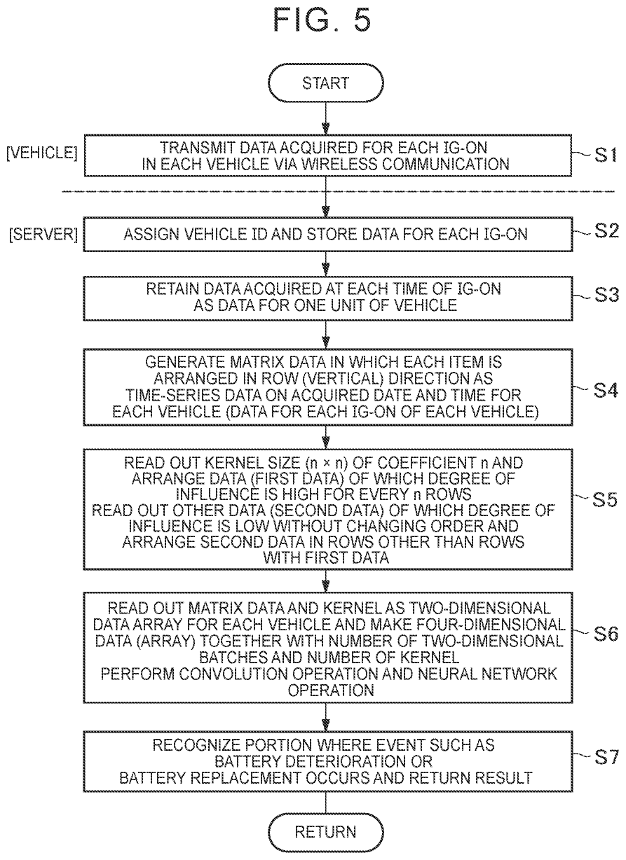

In the flowchart shown in FIG. 5, first, the control unit 6 of the vehicle Ve transmits in step S1 the data (vehicle information) acquired for each vehicle Ve to the server 101 by wireless communication. The vehicle information is acquired, for example, each time an ignition switch (not shown) is turned on (IG-ON) in each vehicle Ve. As described above, transmission of the vehicle information from the control unit 6 of the vehicle Ve to the server 101 provided externally is not limited to be performed by wireless communication, and may be performed using a wired communication device or communication equipment.

Subsequently, in step S2, an identification (ID) number (for example, a vehicle identification number (VIN) set for each vehicle Ve) of each vehicle Ve is assigned to the vehicle information received from each vehicle Ve for each IG-ON time in the server 101, and the vehicle information is stored in the server 101

In step S3, the vehicle information acquired for each IG-ON as described above is retained in the server 101 as individual data for each vehicle Ve. That is, the individual data for each vehicle Ve is temporarily stored in the server 101.

In step S4, as shown in FIGS. 3A, 3B, and 4 as described above, the matrix data M in which the time-series data of the predetermined item that changes continuously in terms of time is arranged in the arrangement direction of each column (or the order direction of the arrangement or the column number direction) is generated with respect to the data of each vehicle Ve. The time-series data in the embodiment of the present disclosure is composed of first data that is the primary factor of the convolution operation and the second data that is the secondary factor of the convolution operation. That is, the time-series data is composed of the first data that has a high degree of influence on the convolution operation and the second data that has a lower degree of influence on the convolution operation than that of the first data. In the example shown in FIG. 4 described above, the “starting voltage of the battery 4” that has a high degree of relevance to deterioration of the battery 4 is arranged in the matrix data M as the first data. In addition, “traveling distance of the vehicle Ve”, “outside air temperature”, “parking time of the vehicle Ve”, etc. are arranged in the matrix data M as the second data.

In step S5, the kernel K of which coefficient (kernel size) is “n” is read from the matrix data M. At that time, the first data is arranged every n rows of the kernel K. The second data is arranged in the remaining rows other than the rows where the first data of the kernel K is arranged. Note that the arrangement order of each data (item) of the vehicle information in the row direction in the matrix data M and the arrangement order of each data (item) of the vehicle information in the kernel K do not necessarily match. In any case, the matrix data M and the kernel K are generated such that when the kernel K is extracted from the matrix data M, the kernel K always contains at least one row of the first data. In the example shown in FIG. 4 described above, the kernel K with a coefficient of “3” is used, and therefore the matrix data M is generated such that at least one row of the first data is arranged every three rows.

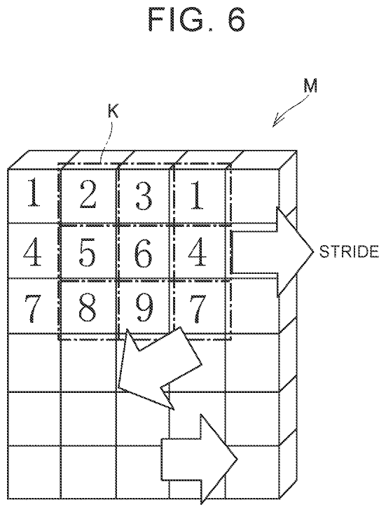

In step S6, the convolution operation and the neural network operation are performed using the matrix data M and the kernel K generated as described above. That is, operations are performed by the convolutional neural network in the embodiment of the present disclosure. In the convolutional neural network, for example, the matrix data M and the kernel K as described above are read out as a two-dimensional data array for each vehicle Ve, and a four-dimensional data array is obtained by multiplying the two-dimensional data by the number of batches of the vehicle information and the number of the kernel K. The kernel K in the convolution operation is extracted from the entire matrix data M by sequentially moving (striding) the position of the kernel K with respect to the matrix data M, for example, as indicated by the arrow in FIG. 6.

Then, in step S7, as described above, learning is performed based on the operation result of the convolutional neural network executed in step S6. That is, the state of the temporal change of the vehicle Ve is estimated. For example, the deterioration state of the battery 4 as described above (the state of the temporal change of performance of the battery 4) is estimated. At that time, for example, as shown in FIG. 4 described above, an abnormality flag extraction range F is set in accordance with the number of the kernel K (stride number) in the matrix data M. As the stride number of the kernel K increases, the abnormality flag extraction range F also expands. Then, as described above, for example, when an abnormality in the state of deterioration of the battery 4 is detected as a result of estimating the state of the temporal change of the vehicle Ve, the abnormality detection flag is turned ON. After step S7 is executed, the routine shown in the flowchart of FIG. 5 is terminated.

As described above, in the learning system and the learning device using the convolutional neural network according to the embodiment of the present disclosure, the matrix data M and the kernel K used in the convolutional neural network are generated by the method of generating the matrix data for the convolutional neural network, which is unique to the embodiment of the present disclosure. With the above, the first data (primary factor) and the second data (secondary factor) as described above are incorporated (convolved) in a composite manner, and learning is performed by the convolution operation. In the example described above, the state of deterioration of the battery 4 mounted on the vehicle Ve is used as a learning object, and the starting voltage of the battery 4 is taken into the convolutional neural network as the first data. Further, factors other than the first data related to the state of deterioration of the battery 4, such as the state of use and environment of use of the vehicle Ve, are taken into the convolutional neural network as the second data. Therefore, in the convolutional neural network according to the embodiment of the present disclosure, as compared with the conventional learning using only the primary factor such as the first data, or the conventional learning in which the primary factor is simply corrected, the learning with higher accuracy can be performed.

Therefore, according to the learning system and the learning device using the convolutional neural network according to the embodiment of the present disclosure, the state of a device, a member, a material or the like that continuously changes in terms of time, for example, the state of deterioration of the battery 4 mounted on the vehicle Ve, can be appropriately and accurately estimated by applying the convolutional neural network.

What is claimed is:

1. A method for generating matrix data for a convolutional neural network that performs a convolution operation based on the matrix data in which predetermined information is arranged as a matrix element, wherein:
the matrix data is composed of predetermined time-series data in which each row of the matrix data changes continuously in terms of time in an arrangement direction of each column of the matrix data;
the time-series data is composed of first data of which a degree of influence on the convolution operation is high and second data of which the degree of influence is lower than the first data,
the convolution operation is performed using a kernel that partitions the matrix data into the rows and the columns corresponding to a predetermined coefficient;
at least one row of the first data is arranged for each set of the rows corresponding to the coefficient; and
the second data is arranged in the remaining rows except for the row in which the first data is arranged.

2. A method for generating matrix data for a convolutional neural network that performs a convolution operation based on the matrix data in which vehicle information with a behavior and a state of each component of a vehicle detected is arranged as a component of a matrix and estimates a state of a temporal change of a predetermined element of the vehicle, wherein:
the matrix data is composed of time-series data of the vehicle information in which each row of the matrix data changes continuously in terms of time in an arrangement direction of each column of the matrix data;
the time-series data is composed of first data of which a degree of influence on the convolution operation is high and that includes at least data related to a primary factor of the temporal change and second data of which the degree of influence is lower than the first data;
the convolution operation is performed using a kernel that partitions the matrix data into the rows and the columns corresponding a predetermined coefficient;
at least one row of the first data is arranged for each set of the rows corresponding to the coefficient; and
the second data is arranged in the remaining rows except for the row in which the first data is arranged.

3. The method according to claim 2, wherein:
the convolutional neural network is for estimating a deterioration state of a power storage device mounted on the vehicle; and
the first data includes at least data related to a voltage of the power storage device.

4. A learning system provided with a control unit mounted on a vehicle and a server installed outside the vehicle, the learning system using a convolutional neural network that estimates a state of a temporal change of a predetermined element of the vehicle by performing a convolution operation based on matrix data in which predetermined information is arranged as a component of a matrix, wherein:
the control unit
acquires vehicle information with a behavior and a state of each component of the vehicle detected, and
transmits the vehicle information to the server; and
the server
configures the matrix data using time-series data of the vehicle information in which each row of the matrix data changes continuously in terms of time in an arrangement direction of each column of the matrix data,
configures the time-series data using first data of which a degree of influence on the convolution operation is high and that includes at least data related to a primary factor of the temporal change and second data of which the degree of influence is lower than the first data,
performs the convolution operation using a kernel that partitions the matrix data into the rows and the columns corresponding to a predetermined coefficient,
arranges at least one row of the first data for each set of the rows corresponding to the coefficient,
arranges the second data in the remaining rows except for the row in which the first data is arranged, and
estimates the state of the temporal change by performing the convolution operation.

5. The learning system according to claim 4, wherein:
the convolutional neural network is for estimating a deterioration state of a power storage device mounted on the vehicle; and
the first data includes at least data related to a voltage of the power storage device.
